(19) United States
(12) Patent Application Publication
(10) Pub. No.: US 2015/0294078 A1
(43) Pub. Date: Oct. 15, 2015

(54) SCHEDULING INSTRUCTION ITEMS

(71) Applicant: KONINKLIJKE PHILIPS N.V., EINDHOVEN (NL)

(72) Inventors: Gijs Geleijnse, Geldrop (NL); Rony Calo, Phoenix, AZ (US); Aleksandra Tesanovic, Eindhoven (NL)

(21) Appl. No.: 14/424,040

(22) PCT Filed: Sep. 5, 2013
(86) PCT No.: PCT/IB2013/058298

§ 371 Date: Feb. 26, 2015

Related U.S. Application Data
(60) Provisional application No. 61/697,324, filed on Sep. 6, 2012.

(51) Int. Cl. G06F 19/00

(52) U.S. Cl. CPC G06F 19/3418; G06F 19/322

(57) ABSTRACT

A system (1) is described for providing a schedule comprising a plurality of instruction items. An assessment unit (2) determines at least one target behavior based on a health record (3), e.g. an electronic health record (EHR) of a patient. An information unit (4) determines a plurality of instruction items based on said at least one target behavior. Furthermore, the information unit (4) associates a first instruction item of the plurality of instruction items with a time duration. A scheduling unit (5) schedules the plurality of instruction items and determines a first presentation time for the first instruction item and a second presentation time for a second instruction item of the plurality of instruction items in dependence on a time period that starts at the first presentation time and has a time duration associated with the first instruction item.

### FIELD OF THE INVENTION

The invention relates to scheduling instruction items.

### BACKGROUND OF THE INVENTION

Healthcare is often provided in a disease-specific manner. When being admitted to hospital for a certain health condition, a patient may receive behavioral recommendations related to one condition. Such recommendations may be offered by means of bed-side patient monitors in the form of educational videos or interactive multimedia content or books or leaflets. If a health condition, e.g. a disease or a disorder, exists simultaneously but independently with another health condition in a patient, these conditions are indicated as co-morbid. For a patient without co-morbidities in an in-patient setting, i.e. a patient staying for example in a hospital, a disease-specific series of content comprising behavioral recommendations is an effective means to educate the patient about the disease, how to deal with the disease and to prepare the patient for coping with the disease or recovering from the disease in an out-patient setting, i.e. in a setting in which the patient is not institutionalized but is staying for example at home. However, for a patient with one or multiple co-morbidities, it may be difficult or impossible to adhere to particular behavioral recommendations mentioned above for example because these recommendations for different diseases are in contradiction with each other.

In the in-patient setting, e.g. during hospitalization, a patient suffering for example from heart failure may typically receive education in the form of discharge instructions comprising behavioral recommendations focusing on the heart failure problem. In the discharge instructions it may be explained to the patient which behaviors he should perform and/or should not perform upon discharge from the hospital. A typical recommendation for a patient having a heart failure problem may be to follow a low-salt diet. However, if this patient is also a diabetic he most probably already follows a dietary regime to control his blood glucose levels. Such a patient may have difficulties implementing the above mentioned recommendation with respect to the low-salt diet in his current diet. In another situation in which a patient is required to refrain for example from any physical activity due to a co-morbidity, adherence to recommendations related to employing physical activity may lead to confusion and/or to non-compliance with such recommendations. Therefore, co-morbid health conditions require a tailored approach with respect to providing lifestyle or behavioral recommendations.

WO 2011/095949 A1 is related to guideline-based patient discharge planning and describes a method that comprises generating via a processor a first signal indicative of a care plane for a heart failure patient with a medical condition based on at least one first predetermined care guideline, generating a second signal indicative of conflicts between multiple additional predetermined care guidelines and the at least one first care predetermined care guideline the care plan is based on for the heart failure patient with co-morbidity, and generating a third signal indicative of contraindications of not following the at least one first predetermined care guideline based in the care plan.

### SUMMARY OF THE INVENTION

It would be advantageous to have an improved system for providing a schedule comprising a plurality of instruction items. To better address this concern, a first aspect of the invention provides a system comprising

an assessment unit for determining at least one target behavior based on a health record of a patient;

an information unit for determining a plurality of instruction items based on said at least one target behavior, wherein a first instruction item of the plurality of instruction items is associated with a time duration;

a scheduling unit for scheduling the plurality of instruction items including determining a first presentation time for the first instruction item and a second presentation time for a second instruction item of the plurality of instruction items in dependence on a time period that starts at the first presentation time and has a time duration associated with the first instruction item.

In this way the second presentation time of the second instruction item of the plurality of instruction items depends on a type of the first instruction item, e.g. an educational video, a leaflet or a counseling interview with a care provider. Each of these instruction items has a different associated time duration. By providing the schedule mentioned above, the system may enable providing a first information item to a patient at an appropriate time, i.e. at a time that the patient is mentally and/or physically ready for handling and/or comprehending the information and/or executing instructions related to at least one recommended target behavior. In the case of a plurality of information items, the schedule may prevent provision of consecutive information items at the same time or too short after each other to the patient. As a result the system may enable a better spreading of educational information to the patient and thereby may enable an improved ability of the patient to handle and comprehend information about the at least one recommended target behavior that is derived by matching patient status and recommended behaviors. In addition, scheduling information items as described above may lead to better adherence by the patient to the at least one recommended target behavior.

The scheduling unit may further be arranged for providing a time interval between the first presentation time and the second presentation time, wherein the time interval has a length that is at least equal to the time duration. In this way a contemplation period may be provided to the patient between the presentation of consecutive instruction items. The second instruction item may be presented to the patient not earlier than the time duration associated with the first instruction item. As mentioned above, the time duration of the first instruction item depends on the type of the first instruction item.

The scheduling unit may be arranged for performing the scheduling of the plurality of instruction items in dependence on information in the health record of the patient. In this way it may be ensured that the patient from a medical perspective is actually capable of performing the recommended target behaviors. This may lead to improved adherence to the recommended target behaviors.

The scheduling unit may be arranged for performing the scheduling of the plurality of instruction items in dependence on a time of a planned intervention in respect of the patient. In this way the presentation of instruction items may be further adapted to the health condition of the patient. This may lead to a more adequate information provision to the patient and possibly to a better understanding about the at least one recommended target behavior and acceptance thereof. Consequently, the patient may show improved adherence to the at least one recommended target behavior.

The scheduling unit may be arranged for determining a time window for presenting said plurality of instruction items, wherein the presentation time further depends on the time window. In this way the scheduling unit may determine a distribution of the at least one presentation time that best suits the health condition of the patient.

The time window may be related to a projected length of stay of the patient in a facility. The time window may for example start at a time of admittance of the patient to a facility, e.g. a hospital. Alternatively, the time window may start at a moment that the patient has recovered enough from an intervention, e.g. a surgery, or has been stabilized through pharmaceutical treatment to start a revalidation process. The time window may be related to the projected length of stay of the patient in the facility such that an end of the time window may be projected.

The information unit may be arranged for determining at least one instruction item based on a first database associating target behaviors with instruction items. In this way a suitable instruction item, e.g. an educational video, a book, a leaflet or a counseling interview with a care provider, may be provided to the patient.

The assessment unit may be arranged for determining a condition of the patient based on information in the health record and determining a target behavior based on the condition of the patient and a second database associating patient conditions with the target behaviors. In this way the target behaviors recommended to the patient may be better adapted to the condition of the patient. Such an improved adaptation may lead to an improved effectiveness of the target behaviors and improved adherence to the target behaviors by the patient.

The information unit may be arranged for determining a first target behavior and a second target behavior and wherein the system further comprises a conflict detector for detecting an incompatibility between the first target behavior and the second target behavior based on a set of incompatibility constraints. In this way the conflict detector may prevent that in the case of co-morbidities the patient is provided with a first target behavior that is incompatible with a second target behavior based on the set of incompatibility constraints that may be based on relations between the co-morbidities. In this way it may be possible to provide the patient with unambiguous recommended target behaviors. This may improve the acceptance of the recommended target behaviors and the adherence to them by the patient. As a result, symptoms may be reduced and consequently the patient's quality of life may be improved.

The system may be arranged such that the first target behavior is associated with a first health problem and the second target behavior is associated with a second health problem. The conflict detector may be arranged for determining the incompatibility between the first target behavior and the second target behavior. In this way the conflict detector may establish the incompatibility based on the first health problem and the second health problem which are associated with respectively the first target behavior and the second target behavior.

The system may be arranged such that the first health problem and the second health problem are associated with different diseases. These diseases can be co-morbidities.

The system may be arranged such that the different diseases are associated with different clinical guidelines. These clinical guidelines may provide information on treating the diseases that they are associated with. In addition, these clinical guidelines may offer instructions for self-care or management of the patient, including lifestyle advice.

In another aspect, the invention provides a workstation comprising the system set forth.

In another aspect, the invention provides a method of scheduling a plurality of instruction items. The method comprises

determining at least one target behavior based on a health record of a patient;

determining a plurality of instruction items based on said at least one target behavior, wherein a first instruction item of the plurality of instruction items is associated with a time duration;

scheduling the plurality of instruction items including determining a first presentation time for the first instruction item and a second presentation time for a second instruction item of the plurality of instruction items in dependence on a time period that starts at the first presentation time and has a time duration associated with the first instruction item.

In another aspect, the invention provides a computer program product comprising instructions for causing a processor system to perform the method set forth.

It will be appreciated by those skilled in the art that two or more of the above-mentioned embodiments, implementations, and/or aspects of the invention may be combined in any way deemed useful.

Modifications and variations of the system, the workstation, the system, the method, and/or the computer program product, which correspond to the described modifications and variations of the system, can be carried out by a person skilled in the art on the basis of the present description.

### BRIEF DESCRIPTION OF THE DRAWINGS

These and other aspects of the invention are apparent from and will be elucidated with reference to the exemplary embodiments described hereinafter. In the drawings,

FIG. 1 is a block diagram of an exemplary embodiment of a system for providing a schedule comprising a plurality of instruction items showing the relations between the different units that the system comprises.

FIG. 2 is a flow chart of a method of scheduling a plurality of instruction items.

### DETAILED DESCRIPTION OF EMBODIMENTS

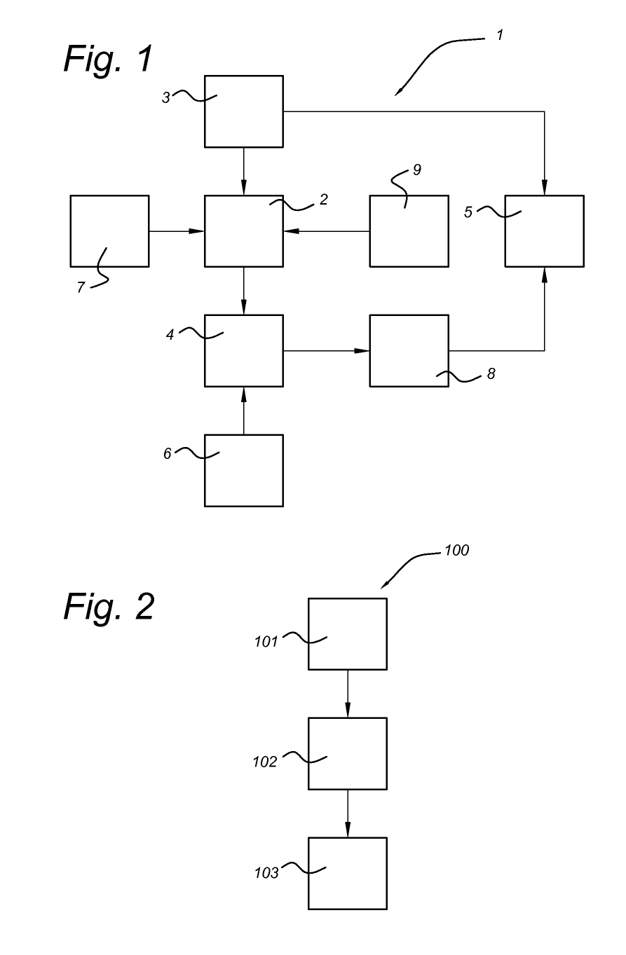

FIG. 1 illustrates an exemplary embodiment of a system 1 for providing a schedule comprising a plurality of instruction items. This system 1 may be implemented on a distributed computer system, for example. Analyzing features may be implemented on a server system, whereas display features may be formed by a client device with a monitor that a user can see. Other arrangements, including a standalone workstation, may also be used to implement the features described herein. Alternatively, the system and/or method described herein may be implemented using dedicated electronic circuitry. Although the system 1 is described herein as comprising a number of units, it will be understood by the skilled person that the same functionality may be divided among a plurality of functional units in a different manner.

Based on a patient's health record 3, which may be an electronic health record (EHR), an assessment unit 2 may determine at least one target behavior for recommendation to the patient. From the EHR 3 the patient's co-morbidities may be derived by using a lookup table of all known co-morbid diseases. An information unit 4 may use the at least one target behavior for determining a plurality of instruction items, such as educational videos or interactive multimedia content or books or leaflets for providing education about the target behavior that may be recommended for improving the patient's health condition. By associating a first instruction item of the plurality of instruction items with a time duration the information unit 4 may provide timing information for scheduling the first instruction item. A scheduling unit 5 may determine a first presentation time for the first instruction item and a second presentation time for a second instruction item of the plurality of instruction items, wherein the second presentation time may be determined in dependence on a time period that starts at the first presentation time and has a time duration associated with the first instruction item. In this way the second presentation time of the second instruction item of the plurality of instruction items depends on a type of the first instruction item, e.g. an educational video, a leaflet or a counseling interview with a care provider. Each of these instruction items has a different associated time duration. By providing the schedule mentioned above, the system 1 may enable providing a first information item to a patient at an appropriate time, i.e. at a time that the patient is ready for handling and/or comprehending the information with respect to at least one recommended target behavior. In the case of a plurality of information items, the schedule may prevent provision of consecutive information items at the same time or too short after each other to the patient. As a result the system 1 may enable a better spreading of educational information to the patient and thereby may enable an improved ability of the patient to handle and comprehend information about the at least one recommended target behavior. In addition, scheduling information items as described above may lead to better adherence by the patient to the at least one recommended target behavior.

By combining the patient's vitals, symptoms and drug side effects, which may be obtained for example via the EHR 3, via sensory devices such as a weight scale or a blood pressure meter and via other equipment such as a pill dispenser, for any co-morbidities, a profile of the patient may automatically be created representing an overall health profile of the patient. This profile may be used to create an adaptive delivery of educational content that may be offered to the patient in an in-patient setting, i.e. when the patient is staying for example in a hospital. Based on a method for automatically generating personalized symptoms assessment and a projected length of stay in for example a hospital, which may also be derived from the EHR 3, the schedule may be computed and dynamically updated in order to present the most relevant educational content for the patient. The schedule of educational content may be created based on an anticipated effectiveness of an intervention and the projected length of stay in the hospital. The presentation of the educational content may be done through instruction items such as bed-side monitors, leaflets, books or a combination of these items.

The scheduling unit 5 may be arranged for having several functions. It may provide a time interval between the first presentation time and the second presentation time, wherein the time interval has a length that is at least equal to the time duration. In this way a contemplation period may be provided to the patient between the presentation of consecutive instruction items. The second instruction item may be presented to the patient not earlier than the time duration associated with the first instruction item. As mentioned above, the time duration of the first instruction item depends on the type of the first instruction item.

The scheduling unit 5 may be arranged for performing the scheduling of the plurality of instruction items in dependence on information in the patient's EHR 3. In this way it may be ensured that the patient from a medical perspective is actually capable of performing the recommended target behaviors. This may lead to improved adherence to the recommended target behaviors.

The scheduling unit 5 may be arranged for performing the scheduling of the plurality of instruction items in dependence on a time of a planned intervention in respect of the patient. In this way the presentation of instruction items may be further adapted to the health condition of the patient. This may lead to a more adequate information provision to the patient and possibly to a better understanding about the at least one recommended target behavior and acceptance thereof. Consequently, the patient may show improved adherence to the at least one recommended target behavior.

The scheduling unit 5 may be arranged for determining a time window for presenting said plurality of instruction items, wherein the presentation time further depends on the time window. In this way the scheduling unit may determine a distribution of the at least one presentation time that best suits the health condition of the patient. The time window may be related to a projected length of stay of the patient in a facility. The time window may for example start at a time of admittance of the patient to a hospital. Alternatively, the time window may start at a moment that the patient has recovered enough from an intervention, e.g. a surgery, to start a revalidation process. The time window may be related to the projected length of stay of the patient in the hospital such that an end of the time window may be projected.

The information unit 4 may be arranged for determining at least one instruction item based on a first database 6 associating target behaviors with instruction items. In this way a suitable instruction item, e.g. an educational video, a book, a leaflet or a counseling interview with a care provider, may be provided to the patient. Table 1 illustrates examples of target behaviors and recommended instruction items as well as time durations associated with the individual instruction items and a contemplation period provided to the patient.

TABLE 1
Examples of target behaviors and recommended instruction items.

| | | | Contemplation |
|---|---|---|---|
| Target behavior | Instruction item | Time duration | period |
| Moderate Physical | Instruction Video | 30 minutes | 24 hours |
| Activity | | | |
| Moderate Physical | Face-to-face | 2 sessions | 48 hours |
| Activity | coaching session | of 1 hour | |
| Low-salt diet | Website | 15 min | 45 min |
| Medication | Instruction video | 20 min | 24 hours |
| Adherence | and book | | |
| Low-salt Diabetes | Session with | 45 minutes | 48 hours |
| diet | Dietician and | | |
| | homework | | |

The assessment unit 2 may be arranged for determining a condition of the patient based on information in the EHR 3 and determining a target behavior based on the condition of the patient and a second database 7 associating patient conditions with the target behaviors. In this way the target behaviors recommended to the patient may be better adapted to the condition of the patient. Such an improved adaptation may lead to an improved effectiveness of the target behaviors and improved adherence to the target behaviors by the patient. The second database 7 may also comprise relations between diseases and their symptoms as well as known side-effects of medication that is offered for treating the diseases. The diseases are also related to a collection of recommended target behaviors that are associated with an importance or impact score. Table 2 illustrates some examples.

TABLE 2
Examples of diseases related to symptoms, side-effects
of medication and recommended target behaviors.

| | Symptoms patient | Recommended target |
|---|---|---|
| | experiences and potential | behaviors (standard from |
| | side effected from | guidelines) and their |
| Disease | associated medication | [impact score] |
| heart | 1. swelling of ankles | 1. physical activity [0.2] |
| failure | 2. fatigue | 2. low salt diet [0.9] |
| | 3. dizziness | 3. decrease fluid intake [0.7] |
| | 4. cough | 4. medication adherence [0.5] |
| | 5. facial rash | |
| COPD | 1. breathlessness | 1. physical activity [0.6] |
| | 2. cough | 2. smoking cessation [0.9] |
| arthritis | joint pain | alcohol cessation [0.3] |
| pneumonia | 1. breathlessness | complete rest [0.8] |
| | 2. pain | |
| | 3. fever | |
| | 4. cough | |
| renal | 1. nausea | 1. increase fluid intake [0.5] |
| dysfunction | 2. fever | 2. low salt diet [0.4] |

Additionally, the second database 7 may comprise at least one combination symptoms/side effects that potentially hamper a recommended target behavior. For example, this list may contain the combinations “joint pain”-“moderate physical activity” and “anxiety”-“stop smoking”. Table 3 shows some examples. It will be clear to the skilled person that this information may also be implemented in a further separate database.

TABLE 3
Examples of recommended target behaviors, related hampering
symptoms and potential conflicting recommended target behaviors.
A score for the hampering symptoms, [hdegree], expresses
an anticipated adverse effect of the symptom with respect
to adherence to the recommended target behavior.

| | | Conflicting |
|---|---|---|
| Recommended target | Hampering symptoms | recommended |
| behavior | [hdegree] | target behavior |
| moderate physical | pain [0.8] | absolute rest |
| activity | breathlessness [0.7] | intense physical activity |
| increase fluid intake | — | decrease fluid intake |
| lower salt intake | — | diabetes type |
| stop smoking | anxiety [0.3] | — |

The databases as described in Tables 1-3 may be composed by combining evidence from multiple sources, e.g. medication databases accessible for example through the internet, patient pathways or clinical practice protocols per disease per hospital or national and international guidelines per disease. For composing the databases mentioned above a database population algorithm may be used comprising the steps of

selecting a disease pathway;

tagging elements in the pathway with relevant labels, i.e. symptoms, recommended target behaviors, medication, to obtain a tagged pathway;

traversing the tagged pathway to create a co-morbidity table;

extracting side-effects from available databases on medication to enrich the co-morbidity table;

extracting hampering symptoms for recommended target behaviors;

storing the co-morbidity table in a database; and

repeating the steps mentioned above when input databases are updated.

The assessment unit 2 may also be connected to input assessment means 9 such as sensors, e.g. weight scale, blood pressure meter, pill dispenser, and questionnaires to determine the patients overall health profile. The assessment unit 2 may use the known co-morbidities as extracted from the EHR 3. These co-morbidities using the second database 7 with symptoms and side-effects. For each of the known symptoms and side-effects, a dedicated input assessment means 9 may be used.

The assessment unit 2 may be arranged for implementing a patient assessment algorithm comprising the steps described next. As a first step an overview is extracted of at least one co-morbidity C from the EHR 3, to obtain a list of co-morbidities known for the patient. As a second step a questionnaire is offered to the patient to verify and expand this list. Table 4 shows illustrates this for an exemplary patient. Note the incompatibility between the third and the last recommended target behavior.

TABLE 4
Exemplary patient suffering from heart failure, COPD
and renal dysfunction. The associated recommended
target behaviors and impact factors are collected.

| Disease | Recommended target behaviors |
|---|---|
| Heart failure | physical activity [20] |
| COPD | low salt diet [90] |
| Renal dysfunction | decrease fluid intake [70] |
| | medication adherence [50] |
| | physical activity [60] |
| | smoking cessation [90] |
| | increase fluid intake [50] |

As a third step at least one potential symptoms/side effects s for the at least one C is gathered for the patient using the data as explained in Table 2. For each s, an assessment means is available. This assessment means may be a sensor-based input, such as a weight scale, blood pressure meter or stethoscope. For symptoms where no sensor-based devices are available, a questionnaire is available to assess its severity. The severity is represented using a score (sev(s), e.g. assessed using a Likert-scale questionnaire of one or multiple questions). The steps mentioned above have the consequences described next. Firstly a collection of symptom severity scores score(s) is obtained. This is illustrated in Table 5. Secondly, a collection of target behaviors b, each associated with an impact score impact(b) is obtained. The collection of target behaviors is a union of at least one target behavior associated with at least one disease known for the patient. If two diseases share a target behavior, the maximum impact score is taken as is illustrated in Table 4. Finally, a number of days until discharge is projected. This projected number may be retrieved from the EHR 3 or may be derived using a predictive model.

TABLE 5
Example collection of symptoms and their
severity for the exemplary patient.

| | | Severity score |
|---|---|---|
| Symptom | Questionnaire | sev(s) |
| swelling of ankles | rate the swelling of your ankles | 80 |
| fatigue | | 70 |
| dizziness | | 70 |
| cough | | 0 |
| breathlessness | | 10 |

The overall profile of the health condition of the patient that may be computed using the steps described above may be used to provide a tailored scheduling of instruction items to the patient.

The information unit 4 may be arranged for determining a first target behavior and a second target behavior and wherein the system 1 further comprises a conflict detector 8 for detecting an incompatibility between the first target behavior and the second target behavior based on a set of incompatibility constraints. In this way the conflict detector 8 may prevent that in the case of co-morbidities the patient is provided with a first target behavior that is incompatible with a second target behavior based on the set of incompatibility constraints that may be based on relations between the co-morbidities. In this way it may be possible to provide the patient with unambiguous recommended target behaviors. This may improve the acceptance of the recommended target behaviors and the projected adherence by the patient. As a result, the patient may have a faster recovery.

The system 1 may be arranged such that the first target behavior is associated with a first health problem and the second target behavior is associated with a second health problem. The conflict detector 8 may be arranged for determining the incompatibility between the first target behavior and the second target behavior. In this way the conflict detector 8 may establish the incompatibility based on the first health problem and the second health problem which are associated with respectively the first target behavior and the second target behavior.

The system 1 as described above prevents that patients may receive conflicting target behaviors that may be dangerous for one or more health conditions that they have. For example, decreased fluid intake is typically recommended to a patient suffering from heart failure. However, in the case of a co-morbid renal dysfunction this patient may already have been advised to increase fluid intake. Furthermore, the system 1 prevents that patients may not be able to perform the recommended target behaviors because of symptoms experienced from co-morbidities, even when the symptoms are reduced. For example, the patient suffering from heart failure and a co-morbid lung condition may experience extreme breathlessness when performing recommended physical activity. Additionally, educating patients may be time-consuming for nurses and/or other medical professionals. The presentation of recommended target behaviors that do not take into account the patient's overall health profile may be ineffective and an unnecessary burden on their workload.

The scheduling unit 5 may be arranged for scheduling an assessment of the patient that may be done according to the patient assessment algorithm described above. A first assessment of the patient is commonly conducted after admission to the facility, e.g. a hospital. Based on this first assessment, an overview of recommended target behaviors and the patient's readiness for adhering to these behaviors is generated using a content scheduling algorithm described below. Based on a score for each of the suitable target behaviors and the projected length of stay in a facility, e.g. a hospital, a schedule for the provision of instruction items may be generated. At pre-determined moments, e.g. each day, or after each consumed instruction item, the patient may be reassessed and the instruction items may be rescheduled.

The content scheduling algorithm mentioned above comprises the steps described below. A first step comprises computing an overall health profile of the patient using the patient assessment algorithm described above. This profile may be used to compute a success score for the relevant recommended target behaviors based on the combination of hampering symptoms and their severity scores.

Using the database as described in Table 3, for each behavior b, hampering symptom s, a hampering degree hdegree(b,$) is associated. The hampering degree is combined with the severity score sev(s) for the symptom into a hampering score h(b,$). To this end, the multiplication of the severity score and hampering degree can be taken. Here, h(b,$) expresses, on a range from 0-1, the likeliness that a symptom prevents the patient for engaging in recommended target behavior b.

For each target behavior b, an overall acceptance score f(b) may be computed by combining associated and applicable symptoms factors h(b,$). This may again be done by multiplying associated h(b,s′) for symptoms s′.

The target behaviors b may be prioritized by combining the acceptance scores f(b) with the impact score impact(b) into a success score g(b). Once again, the multiplication of the two may be used to compute the success score g(b). This may result in an ordered list of recommended target behaviors.

The list of recommended target behaviors may be scanned to combine behaviors, e.g. low salt diet with low sugar diets. To this end, a list may be maintained with combined behaviors that are associated with two or more target behaviors. If such combinations are detected, the highest ranked target behavior may be replaced with the combined behavior, while the other associated target behaviors may be removed from the priority list.

The list of recommended target behaviors may be scanned for conflicting behaviors using the database as illustrated in Table 3. The conflicting behaviors are highlighted and presented to for example a clinician responsible for educating a patient.

Based on the automatically generated alerts for conflicting recommended target behaviors, the clinician may be invited to review and edit the list of target behaviors.

Using the database as illustrated in Table 1, an instruction item may be associated with a target behavior, a time duration, e.g. length of a video fragment, and a contemplation period. The contemplation period may be used to define a time interval between offering two instruction items.

The projected length of stay in a facility, e.g. a hospital, may be extracted from the database. This can be based on a data field, or an estimate based on a model. The average length of stay of previous patients with similar conditions may be a candidate for projecting the length of stay.

Based on the projected length of stay and the health condition of the patient, a moment for first offering an instruction item and the moment of discharge may be projected. This resolves in a time window, i.e. available time.

A best match between the available time and the success of the interventions associated with the instruction items may be computed, based on the time durations associated with the instruction items and the scores g(b). This results in the so-called knapsack problem and may be handled by a combinatorial optimization algorithm, e.g. a greedy algorithm.

The instruction item may be presented and the target behavior may be removed from the list of prioritized behaviors.

Each time a new assessment is available the abovementioned corresponding steps are repeated.

Above it has been assumed that available instruction items for a particular target behavior have a similar effect and cost. However, a scenario may be envisioned in which a more expensive instruction item, e.g. a personal face-to-face session, may be expected to be more effective than a lower cost instruction item, e.g. a video. In this scenario, the scheduling algorithm may be slightly adapted as follows.

The original success score g(b) may be combined with the effectiveness score per instruction item. Success may now be determined based on the patient's condition and the anticipated effectiveness of the intervention. Hence, per recommended target behavior, a success score per instruction item may be associated. Next, each instruction item may be associated with a cost and a budget per patient may be defined. This budget may be a fixed number or a budget that is dependent on the patient's length of stay.

The combinatorial algorithm, e.g. greedy algorithm, may be executed with the following additional requirements. First, the success score may be defined per instruction item. Second, at most one instruction item may be offered per recommended target behavior. Third, the budget may not be exceeded.

FIG. 2 illustrates a method 100 of scheduling a plurality of instruction items. In step 101 of the method at least one target behavior is determined based on a health record of a patient.

In step 102 of the method a plurality of instruction items is determined based on said at least one target behavior. A first instruction item of the plurality of instruction items is associated with a time duration.

In step 103 of the method the plurality of instruction items are scheduled. This includes determining a first presentation time for the first instruction item and a second presentation time for a second instruction item of the plurality of instruction items in dependence on a time period that starts at the first presentation time and has a time duration associated with the first instruction item.

It will be understood by the skilled person that the method 100 may be extended and/or modified based on the functionality described herein in respect of the system 1 for providing a schedule comprising a plurality of instruction items. Moreover, the method 100 and the system 1 may be implemented by means of a computer program product.

The techniques described herein may be applicable across and beyond all the clinical information systems areas. Any medical system that allows some form of interaction with the whole or part of a patient record may provide additional benefit by implementing the techniques disclosed herein. Moreover, non-medical information systems may also benefit from these techniques.

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a flash drive or a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for providing a schedule comprising a plurality of instruction items, comprising
an assessment unit for determining at least one target behavior based on a health record of a patient;
an information unit for determining a plurality of instruction items based on said at least one target behavior, wherein a first instruction item of the plurality of instruction items is associated with a time duration;
a scheduling unit for scheduling the plurality of instruction items including determining a first presentation time for the first instruction item and a second presentation time for a second instruction item of the plurality of instruction items in dependence on a time period that starts at the first presentation time and has a time duration associated with the first instruction item.

2. The system according to claim 1, wherein the scheduling unit is further arranged for providing a time interval between the first presentation time and the second presentation time, wherein the time interval has a length that is at least equal to the time duration.

3. The system according to claim 1, wherein the scheduling unit is arranged for performing the scheduling of the plurality of instruction items in dependence on information in the health record of the patient.

4. The system according to claim 1, wherein the scheduling unit is arranged for performing the scheduling of the plurality of instruction items in dependence on a time of a planned intervention in respect of the patient.

5. The system according to claim 1, wherein the scheduling unit is arranged for determining a time window for presenting said plurality of instruction items, wherein the presentation time further depends on the time window.

6. The system according to claim 5, wherein the time window is related to a projected length of stay of the patient in a facility.

7. The system according to claim 1, wherein the information unit is arranged for determining at least one instruction item based on a first database associating target behaviors with instruction items.

8. The system according to claim 1, wherein the assessment unit is arranged for determining a condition of the patient based on information in the health record and determining a target behavior based on the condition of the patient and a second database associating patient conditions with the target behaviors.

9. The system according to claim 1, wherein the information unit is arranged for determining a first target behavior and a second target behavior and wherein the system further comprises a conflict detector for detecting an incompatibility between the first target behavior and the second target behavior based on a set of incompatibility constraints.

10. The system according to claim 9, wherein the first target behavior is associated with a first health problem and the second target behavior is associated with a second health problem and the conflict detector is arranged for determining the incompatibility between the first target behavior and the second target behavior.

11. The system according to claim 10, wherein the first health problem and the second health problem are associated with different diseases.

12. The system according to claim 11, wherein the different diseases are associated with different clinical guidelines.

13. A workstation comprising the system according to claim 1.

14. A method of scheduling a plurality of instruction items, comprising
determining at least one target behavior based on a health record of a patient;
determining a plurality of instruction items based on said at least one target behavior, wherein a first instruction item of the plurality of instruction items is associated with a time duration;
scheduling the plurality of instruction items including determining a first presentation time for the first instruction item and a second presentation time for a second instruction item of the plurality of instruction items in dependence on a time period that starts at the first presentation time and has a time duration associated with the first instruction item.

15. A computer program product comprising instructions for causing a processor system to perform the method according to claim 14.
